(19) United States
(12) Patent Application Publication
(10) Pub. No.: US 2014/0310092 A1
(43) Pub. Date: Oct. 16, 2014

(54) METHOD AND SYSTEM FOR FACILITATING AN INTERACTIVE MERCHANT MARKETING RELATIONSHIP BETWEEN MERCHANTS AND CUSTOMERS

(71) Applicants: Nathan Joseph Maggio, Clearwater, FL (US); Mark Michael Warady, Clearwater, FL (US); James Kenneth Lee, Clearwater, FL (US)

(72) Inventors: Nathan Joseph Maggio, Clearwater, FL (US); Mark Michael Warady, Clearwater, FL (US); James Kenneth Lee, Clearwater, FL (US)

(21) Appl. No.: 14/289,644

(22) Filed: May 28, 2014

Related U.S. Application Data
(60) Provisional application No. 61/829,676, filed on May 31, 2013.

(51) Int. Cl. G06Q 30/02

(52) U.S. Cl. CPC G06Q 30/0242
USPC 705/14.41

(57) ABSTRACT

A system for facilitating a bi-directional communication between a business provider and a business recipient, that allows a business provider to provide a targeted and profiled business recipient with information that is tailored specifically for that business recipient in an effort to solicit that business recipient's business. Conversely, the system facilitates a bi-directional communication between a business recipient and a business provider that allows a business recipient to request information from a targeted and profiled business provider that is tailored specifically for that business recipient, in an effort to obtain the business recipient's business.

### BACKGROUND OF THE INVENTION

First off, the goal of marketing and advertising has always been to gain more exposure in the market, with the intention of acquiring new customers. The problem with most marketing attempts is that the merchant advertises what they think their customers want, without the empirical data to back up that assumption.

Additionally, most marketing firms and their respective merchants employ a marketing technique, whereby discounts, coupons, promotions, and offers are advertised to the public with the hope that a potential customer will be enticed to redeem the offer.

Furthermore, even if the customer redeems the coupon, promotion, discount, or offer, the merchant rarely has a way of tracking what drove the customer to their business. And, since it is difficult for merchants to determine which offers are working, or where this new customer business was driven from, this marketing technique leaves merchants in a vicious cycle of repeating the same process and receiving the same inconclusive results.

Online Referral Marketing

Online Referral Marketing is a structured and systematic process to maximize [word of mouth] potential. This enhances the traditional method of referral marketing that is focused on encouraging, informing, promoting and rewarding customers and contacts to think and talk as much as possible about the supplier, the company, product and service, and the value and benefit the supplier brings to them and the people they know. This form of marketing takes [word of mouth] from the spontaneous situation, to one where maximum referrals are generated.

Online referral marketing, using digital marketing as a platform, is the internet based approach to referral marketing. Given the advances in the Internet recording of customer behavior, Online Referral Marketing provides a high degree of that tracking and accountability.

People feel more comfortable when a product or service is recommended by someone they know and trust. This is especially true if the product or service is in a higher price range. Referrals do not involve direct selling. Instead, a satisfied customer sells the products and services for you.

If a customer tells a close friend about a certain business, then their trust is immediately transferred to the company, irrespective of whether they have heard about it or not.

Because people trust the word of friends, they are more likely to take a referral for your business if one is given to them. This results in net-new business opportunities, without any significant advertising or marketing costs. In essence, referrals build a level of satisfied customers. This cycle self-perpetuates with more satisfied customers referring others to your company.

Email, blogs, social networks, Short Message Service (SMS), and even the telephone, are not separate islands of technology, but overlapping communication channels. Recommending a restaurant, forwarding an email, telling a friend about a Web site or application, are all known as referral marketing.

Online Referral Marketing has evolved to be one of the most effective and crucial forms of advertising in the business world today. More than television, direct mail, or any form of Pay Per Click (PPC) advertising, referral marketing is the preferred way to jump over the trust factor that can come from a competitive sales environment. There is no form of sales more effective than a good friend sharing a great experience.

Online Merchant Marketing

Online Merchant Marketing is a way for merchants to incorporate an [online marketing effort] in the organization of selling and distribution of the merchandises and services that are being offered. Merchants are selling their products and services all over the Internet, and they are applying Internet marketing strategies to get their message out and convert more sales online by various Internet marketing techniques and tactics, such as search engine optimization, web site marketing, viral marketing, affiliate marketing and so on. Online Merchant Marketing is comprised of Affiliate, Cost Per Action and Pay Per Click marketing techniques.

Affiliate Marketing

Affiliate marketing is a type of performance-based marketing in which a business rewards one or more affiliates for each visitor or customer brought about by the affiliate's own marketing efforts.

The industry has four core players: the merchant (also known as ‘retailer’ or ‘brand’), the network (that contains offers for the affiliate to choose from, and also takes care of the payments), the publisher (also known as ‘the affiliate’) and the customer. The market has grown in complexity to warrant a secondary tier of players, including affiliate management agencies, super-affiliates and specialized third party vendors.

Affiliate marketing overlaps with other Internet marketing methods to some degree, because affiliates often use regular advertising methods. Those methods include organic search engine optimization (SEO), paid search engine marketing, Pay Per Click (PPC), e-mail marketing, and in some sense display advertising. On the other hand, affiliates sometimes use less orthodox techniques, such as publishing reviews of products or services offered by a partner.

Affiliate marketing is commonly confused with referral marketing, as both forms of marketing use third parties to drive sales to the merchant. However, both are distinct forms of marketing, and the main difference between them is that affiliate marketing relies purely on financial motivations to drive sales, while referral marketing relies on trust and personal relationships to drive sales.

Cost Per Action

Cost Per Action (sometimes known as Pay Per Action or PPA) is an online advertising pricing model, whereby the advertiser pays for each specified action (a purchase, a form submission, and so on) linked to the advertisement.

Direct response advertisers consider Cost Per Action the optimal way to buy online advertising, as an advertiser only pays for the ad when the desired action has occurred. An action can be a product being purchased, a form being filled, and so on. The desired action to be performed is determined by the advertiser. Radio and TV stations also sometimes offer unsold inventory on a cost per action basis, but this form of advertising is most often referred to as “per inquiry.”

Pay Per Click

Pay Per Click advertising provides an easy, cost-efficient way for small businesses to compete with businesses of all kind: You only pay when someone clicks on your Ad.

With Pay Per Click, business owners can target Internet users who are searching for specific terms related to their business. If you own a shoe store, for example, and you want people to know that you sell a particular brand, you can create an ad that will appear when people search for that brand. Since it is likely that consumers are using search engines to research products and services before making a purchase, Pay Per Click will drive traffic to your website with the hope of bringing in business.

When it comes to turning browsers into buyers, Pay Per Click is often more effective than Search Engine Optimization, commonly known as SEO, which makes your website appear at a higher position in unpaid search results. With Pay Per Click, you're paying to be sure your Ad will rise to the top of results. With search engine optimization, there are no guarantees that your content will rise to the top.

Marketing Industry Players

The top players in this industry are currently well established and entrenched as the market leaders, with a commanding hold on the bulk of the market share. Thus, making an entry point at this level is unreasonable and should be discouraged from a business standpoint. These companies do not base their business on “advertising revenue” alone, but have a business structure that lends itself to bolting on to these auxiliary services offerings in an effort to drive increased revenues in their core business.

The middle players are equally well established and own most of their market share, as well. However, they each are experiencing considerable growing pains, as they look to achieve their ongoing financial projections. This demands additional and unexpected financial investment, that are above and beyond the budgeted plan.

In addition, these companies are [without exception] also struggling with how to continually stoke their existing customer base, after the initial new member excitement and savings experience has faded, and the continual flood of promotional advertisements they receive daily, become more of a inconvenience and a nuisance to their personal life than desired.

The resulting outcome is an erratic drop off in existing member participation in the “pushed daily promotions”, which always has a negative impact on a company's ability to accurately forecast future revenue achievement. This leaves the burden of picking up the lost re-occurring revenue stream to the customer facing sales organization. They must not only acquire net-new merchant business to meet present forecasts, but must also make up for the lost revenue from the existing customer base that has become lackadaisical in their patronage and buying patterns.

Stabilizing the erratic customer retention rate and non-consistent participation in daily programs is crucial before any significant effort or investment is placed on acquiring new business.

Otherwise, the newly acquired revenue stream on the front end of the business becomes the primary input to the financial hole on the back end, thus mapping out an exponential trajectory of the company's revenue projections. Clearly, not the desired course that management, nor the investment team, is very fond of.

There is a sweet spot in the market that usually belongs to the small independent regional marketing firms. The merchants that they engage with are typically one owner establishments, with a local customer base that has taken years to stabilize and become somewhat profitable.

These merchant's marketing budgets are usually non-existent, or they take advantage of strategic one-off advertising efforts [such as magazine Ads, flyers, etc]. Their business forecasts are traditionally based on simply preserving their existing customer base and providing a consistent delivery of quality products and services, along with maintaining high levels of customer satisfaction, with the hope of obtaining a consistent amount of repeat business.

It goes without saying that the small merchant's marketing needs are no less important than that of the much larger companies. They just don't have the financial wherewithal to apply greater sums of money to acquiring new customers. So, they reserve themselves to using the old tried and true method of growing their businesses organically—one satisfied customer at a time, and over a prolonged period of time. This is where “word of mouth” marketing is “King”.

However, with the advent of ubiquitous mobile communications, social networking, and the Internet, coupled with robust and cost effective online marketing applications, full coverage advertising in a particular community is achievable on the most meager of Small to Medium Business (SMB) marketing budgets.

There are a host of small regional marketing organizations popping up across the nation, mimicking the business structure and model of companies like Yelp, LivingSocial and Foursquare (albeit, on a much smaller scale).

The consequence of replicating and deploying this exact form of advertising and marketing, brings with it the same problems [proportionally] to that which the larger firms currently have to contend with. Fortunately, the larger firms have built-in mechanisms that allow them to recover from moderate unexpected financial losses, as an integral part of running the business. Unfortunately, the regional firms do not, and will usually bleed out before they can adjust their course and avoid financial demise.

This was never more evident than the disastrous business outcome of the dot com era that eventually climaxed back in early 2000. Learning from history and embracing business processes that have proven to be consistent, time and time again, is key to running a successful business. This is only second to employing effective leadership, hiring talented employees, maintaining positive cash flow, and exercising prudent and responsible P&L management.

### BRIEF DESCRIPTION OF THE SEVERAL VIEWS OF THE DRAWINGS

FIG. 1 illustrates the overall INTERACTIVE MERCHANT MARKETING design and operational structure. Each item listed (illustrated as [001-005]) can be deployed on separate platforms, in a myriad of possible configurations, provided that an efficient communications vehicle is utilized between the items.

[001] illustrates the individual MERCHANT or MERCHANTS, that are able to access the INTERACTIVE MERCHANT MARKETING services (illustrated in [003]), via their specific MERCHANT ACCESS POINT (illustrated in [002]).

The MERCHANTS are required to be authorized, via a contract agreement, to log on to the MERCHANT ACCESS POINT (illustrated in [002]), in order to access the INTERACTIVE MERCHANT MARKETING services (illustrated in [003]).

[002] illustrates the MERCHANT ACCESS POINT in which a MERCHANT or MERCHANTS (illustrated in [001]), logs on to and accesses the INTERACTIVE MERCHANT MARKETING services (illustrated in [003]).

The MERCHANT ACCESS POINT facilitates access to the INTERACTIVE MERCHANT MARKETING services (illustrated in [003]), that will allow the MERCHANT or MERCHANTS (illustrated in [001]), to develop an interactive merchant marketing relationship between a CUSTOMER or CUSTOMERS (illustrated in [005]).

[003] illustrates the INTERACTIVE MERCHANT MARKETING services that allow a MERCHANT or MERCHANTS (illustrated in [001]), to develop an interactive merchant marketing relationship with a CUSTOMER or CUSTOMERS (illustrated in [005]), in which to promote their products and services. And conversely, to allow a CUSTOMER or CUSTOMERS (illustrated in [005]), to directly interact with a MERCHANT or MERCHANTS (illustrated in [001]), regarding their request for a customized and tailored discount on their products and services.

The INTERACTIVE MERCHANT MARKETING services provide the functionality that connects a MERCHANT or MERCHANTS (illustrated in [001]), to a CUSTOMER or CUSTOMERS (illustrated in [005]), and conversely, provides the functionality that connects a CUSTOMER or CUSTOMERS (illustrated in [005]), to a MERCHANT or MERCHANTS (illustrated in [001]).

[004] illustrates the CUSTOMER ACCESS POINT in which a CUSTOMER or CUSTOMERS (illustrated in [005]), logs on to and accesses the INTERACTIVE MERCHANT MARKETING services (illustrated in [003]).

The CUSTOMER ACCESS POINT facilitates access to the INTERACTIVE MERCHANT MARKETING services (illustrated in [003]), that will allow the CUSTOMER or CUSTOMERS (illustrated in [005]), to develop an interactive merchant marketing relationship between a MERCHANT or MERCHANTS (illustrated in [001]).

[005] illustrates the individual CUSTOMER or CUSTOMERS, that are able to access the INTERACTIVE MERCHANT MARKETING services (illustrated in [003]), via their specific CUSTOMER ACCESS POINT (illustrated in [004]).

The CUSTOMERS are required to be authorized, via a contract agreement, to log on to the CUSTOMER ACCESS POINT (illustrated in [004]), in order to access the INTERACTIVE MERCHANT MARKETING services (illustrated in [003]).

FIG. 2 is a high level representation of the three major components of a composite model of the invention that will be used to demonstrate the interactive communication path between an INPUT USER and an OUTPUT USER.

FIG. 2A is a flow diagram representing the complete path in which an INPUT USER solicits a predetermined, targeted OUTPUT USER with an offer, and that offer being accepted by the OUTPUT USER, is subsequently forwarded to the INPUT USER.

This process starts at the INPUT USER location represented by a CIRCLE X. The INPUT USER queries the SYSTEM to identify an OUTPUT USER that best matches the profile of the specific offer that the INPUT USER wants to solicit to the OUTPUT USER.

Based on the query search results, the INPUT USER creates an offer to send to the OUTPUT USER.

The INPUT USER instructs the SYSTEM to forward the offer to the predetermined, targeted OUTPUT USER.

The OUTPUT USER chooses to accept the INPUT USER solicitation by instructing the SYSTEM to forward the accepted offer to the INPUT USER.

Throughout this entire process, the SYSTEM stores the transaction data associated with each phase of the INPUT USER and OUTPUT USER dialogue for future use by the INPUT USER.

FIG. 2B is a flow diagram representing the complete path in which an INPUT USER solicits a predetermined, targeted OUTPUT USER with an offer, and the OUTPUT USER chooses to modify the INPUT USER offer, and instructs the SYSTEM to forward the modified offer to the INPUT USER for approval.

This process starts at the INPUT USER location represented by a CIRCLE X. The INPUT USER queries the SYSTEM to identify an OUTPUT USER that best matches the profile of the offer that the INPUT USER wants to solicit to the OUTPUT USER.

Based on the query search results, the INPUT USER creates an offer to send to the OUTPUT USER.

The INPUT USER instructs the SYSTEM to forward the offer to the predetermined, targeted OUTPUT USER.

The OUTPUT USER receives the INPUT USER offer and chooses to modify that offer, and instructs the SYSTEM to forward the modified offer to the INPUT USER for approval.

The INPUT USER receives the OUTPUT USER modified offer, and the INPUT USER chooses to accept the OUTPUT USER modified offer, and instructs the SYSTEM to forward the approved modified offer back to the OUTPUT USER.

The output user receives the INPUT USER approved modified offer, and instructs the SYSTEM to forward the OUTPUT USER response to the INPUT USER.

Throughout this entire process, the SYSTEM stores the transaction data associated with each phase of the INPUT USER and OUTPUT USER dialogue for future use by the INPUT USER.

FIG. 2C is a flow diagram representing the complete path in which an OUTPUT USER solicits a predetermined, targeted INPUT USER with a request for an offer, resulting in an INPUT USER submitting an initial offer to the OUTPUT USER, based upon the OUTPUT USER request, and the OUTPUT USER accepting or modifying the INPUT USER initial offer. The INPUT USER chooses to either submit a modified initial offer, if the OUTPUT USER has modified the INPUT USER initial offer, or the INPUT USER submits a final offer confirming the OUTPUT USER offer request.

This process starts at the OUTPUT USER location represented by a CIRCLE X. The OUTPUT USER queries the SYSTEM to identify a predetermined, targeted INPUT USER with a request for an offer that the OUTPUT USER wants to solicit to the INPUT USER.

Based on the query search results, the OUTPUT USER creates a request for an INPUT USER initial offer and submits it to the INPUT USER.

The OUTPUT USER instructs the SYSTEM to forward that request to the predetermined, targeted INPUT USER.

The INPUT USER receives the OUTPUT USER request for an offer, and the INPUT USER chooses to submit an offer based upon the OUTPUT USER request, and instructs the SYSTEM to forward that response to the OUTPUT USER for acceptance.

The OUTPUT USER receives the INPUT USER initial offer, and the OUTPUT USER chooses to either accept the INPUT USER initial offer, or modify the INPUT USER initial offer, and instructs the SYSTEM to forward that response to the INPUT USER.

The INPUT USER has the option to continue in this bidirectional negotiation with the OUTPUT USER until a final offer is agreed upon.

The INPUT USER then instructs the SYSTEM to submit an OUTPUT USER offer acceptance confirmation to the OUTPUT USER.

The OUTPUT USER receives the OUTPUT USER offer acceptance confirmation from the INPUT USER.

Throughout this entire process, the SYSTEM stores the transaction data associated with each phase of the INPUT USER and OUTPUT USER dialogue for future use by the INPUT USER.

### DETAILED DESCRIPTION OF THE INVENTION

Reference will now be made to various and alternative exemplary embodiments of the invention. The following is a high level overview of the required system resources with a detailed description on the invention's operation, functional and transactional flow. This will be thoroughly outlined in the invention's four key operational scenarios listed below. These scenarios of operation are provided by way of example for ease of explanation, and not as a limitation. It should be noted that modifications and variations can be made without departing from the scope or spirit of the disclosure and claims. For instance, features illustrated or described as part of one embodiment may be used on another embodiment to yield a still further embodiment. Thus, it is intended that the present disclosure includes modifications and variations, as come within the scope of the appended claims and their equivalents.

The technology discussed herein makes reference to servers, databases, software applications, and other computer based systems, as well as actions taken, and information sent to and from such systems. The inherent flexibility of computer based systems allows for a great variety of possible configurations, combinations, and divisions of tasks and functionality between and among components. For instance, server processes discussed herein may be implemented using a single server or multiple servers working in combination.

Databases and applications may be implemented on a single system or distributed across multiple systems. Distributed components may operate sequentially or in parallel. When data is obtained or accessed between a first and second computer system, or a component thereof, the actual data may travel between the systems directly or indirectly. For example, if a first computer accesses a file or data from a second computer, the access may involve one or more intermediary computers, proxies, and the like. The actual file or data may move between the computers, or one computer may provide a pointer or metafile, so that the second computer user may access the actual data from a computer other than the first computer, for instance.

The present disclosure also makes reference to the relay of communicated data over a network such as the Internet. It should be appreciated that such network communications may also occur over alternative networks such as a Dial-Up Network, a Local Area Network (LAN), Wide Area Network (WAN), Public Switched Telephone Network (PSTN), Intranet, and others over any combination of hard wired or wireless communication links.

The various computer systems discussed herein are not limited to any particular hardware architecture or configuration. Any suitable programming, scripting, or other type of language or combinations of languages may be used to implement the teachings contained herein.

Embodiments of the methods and systems set forth herein may be implemented by one or more general purpose or customized computing devices, accessing software instructions that are rendered in a computer readable form. Embodiments of the methods and systems set forth herein may also be implemented by hard wired logic or other circuitry, including, but not limited to application specific circuits. Of course, combinations of computer executed software and hard wired logic may be suitable, as well.

Embodiments of the methods disclosed herein may be executed by one or more suitable computing devices. Such devices may access one or more computer readable media that embody computer readable instructions which, when executed by at least one computer, cause the at least one computer to implement one or more embodiments of the methods disclosed herein. Furthermore, components of the presently disclosed technology, such as knowledge bases and data stores, may be implemented using one or more computer readable media. Any suitable computer readable medium or media may be used, including diskettes, drives, and other magnetic based storage media, optical storage media, including disks (including CD-ROMS, DVD-ROMS, and variants thereof), flash, RAM, ROM, and other memory devices, and the like.

The following scenarios listed below are presented with the intent to provide the reader with a simplified and concise description of the invention's intended embodiment and associated operation.

Scenario 1:

A merchant decides to solicit a customer with a specific customized and tailored merchant offer.

The merchant must first utilize an Internet capable device to connect to an Internet addressable Interactive Merchant Marketing system.

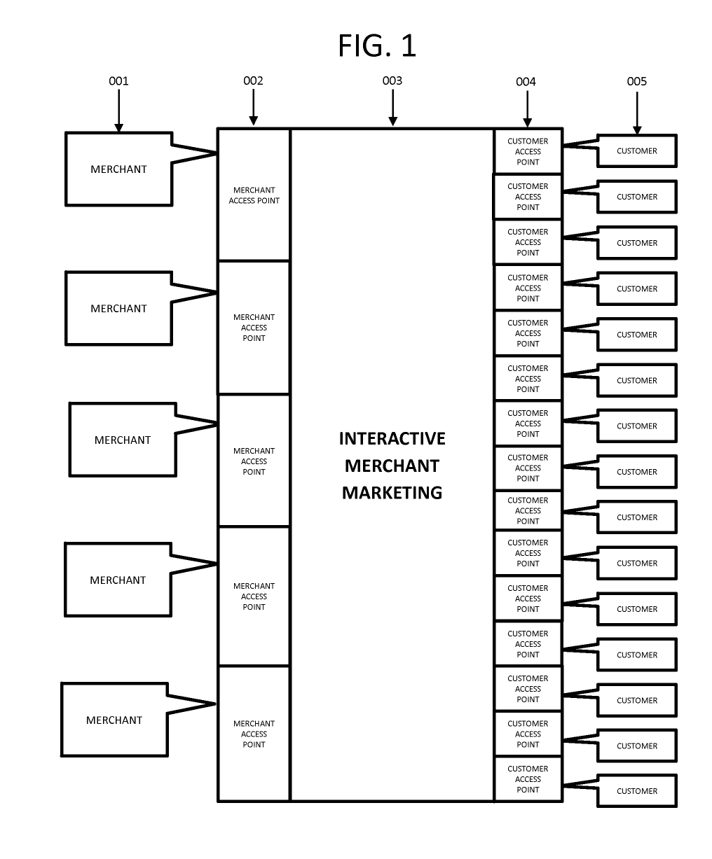

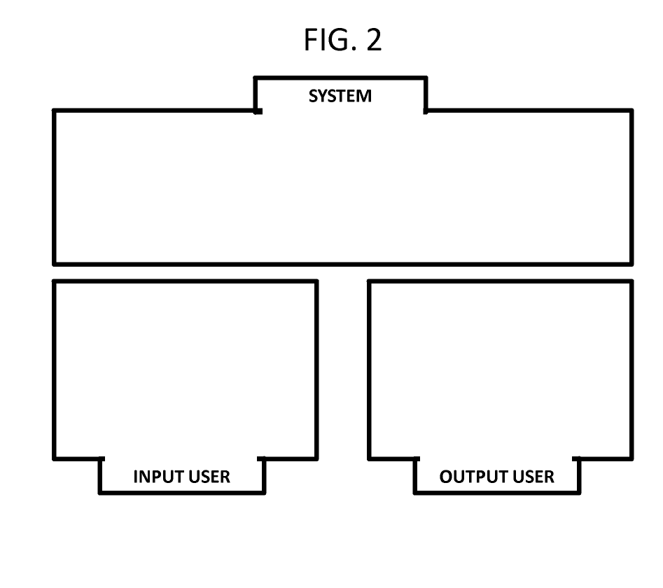

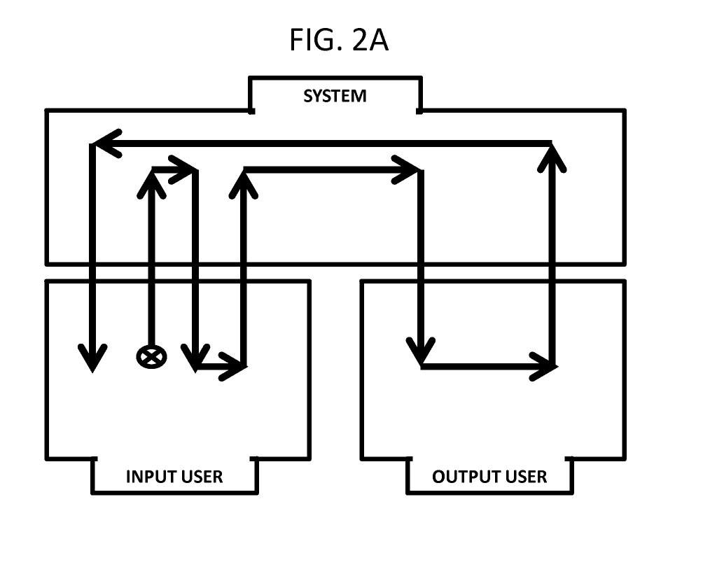

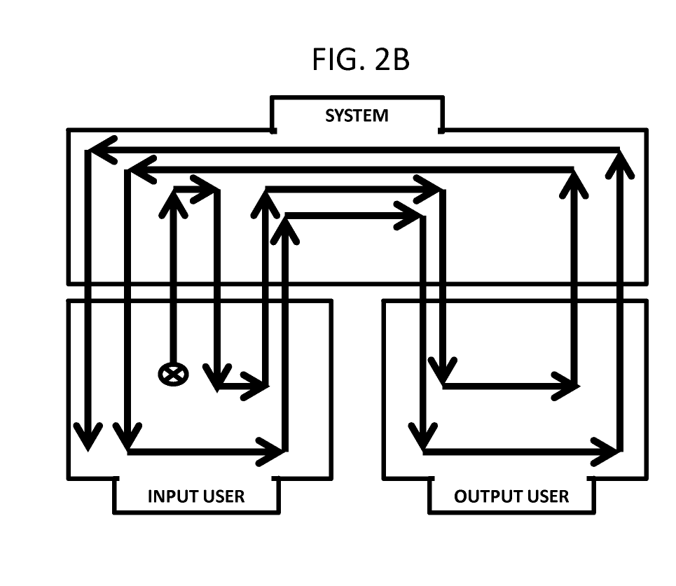

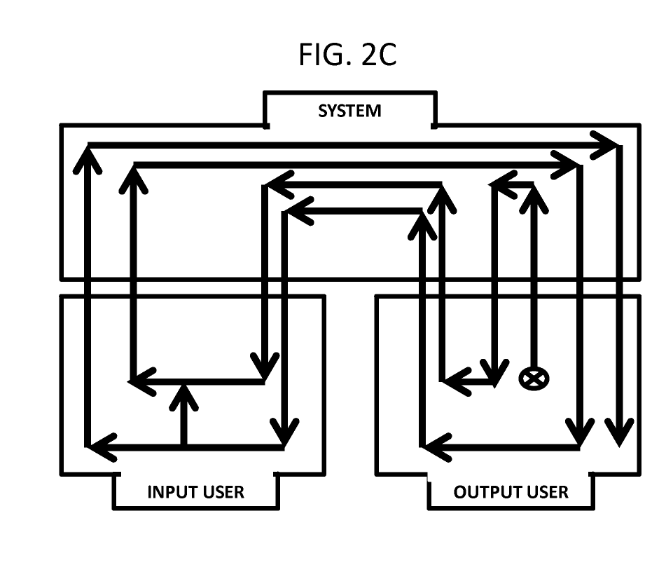

Once connected, the merchant must log on to the system with a dedicated merchant User ID and Password (logically depicted in FIG. 1 as the “Merchant Access Point”) in order to access the services authorized for that specific merchant.

Once logged on, the merchant can query a series of dedicated databases (containing merchant, customer and system related data) in an effort to identify a specific customer [along with the customer profile and associated contact information] that best match the merchant's query parameters.

The merchant can then access additional Interactive Merchant Marketing services that allow the merchant to create a customized and tailored offer that is to be sent to the targeted customer.

The merchant then instructs the Interactive Merchant Marketing system to send the merchant's new offer to the customer's Internet capable device that is recorded in the merchant's customer database.

The Interactive Merchant Marketing system formats the merchant's customized and tailored offer to match the presentation logic requirements of that specific customer's Internet capable device.

The Interactive Merchant Marketing system will then send the formatted merchant offer to the customer, via the Interactive Merchant Marketing, Customer Access Point (logically depicted in FIG. 1, as the “Customer Access Point”).

The customer receives and reviews the merchant's offer, along with a selectable “Customer Response” option [displayed on the customer's Internet capable device] that allows the customer to accept, decline, negotiate, or opt out of the merchant's solicitation.

Once the customer selects the appropriate response option, the program logic embedded in the merchant's formatted offer sends the customer response to the Interactive Merchant Marketing system, via the “Customer Access Point”, and instructs the system to send the customer response to the merchant.

The system sends the customer response to the merchant, via the “Merchant Access Point” that is associated with that specific merchant.

The merchant reviews the customer response and has the option of accessing additional Interactive Merchant Marketing system services to perform other administrative type merchant activities.

Throughout this entire process, the Interactive Merchant Marketing system stores the transaction data associated with every phase of the dialogue between the merchant and customer. This data can be viewed and queried for future use by the merchant.

The merchant could have optionally chosen to create a list of target customers, rather than a single customer, and instructed the system to repeat the entire process with each targeted customer.

Scenario 2:

A customer decides to solicit a merchant for a specific customized and tailored merchant offer.

The customer must first utilize an Internet capable device to connect to an Internet addressable Interactive Merchant Marketing system.

Once connected, the customer must log on to the system with a dedicated customer User ID and Password (logically depicted in FIG. 1 as the “Customer Access Point”) in order to access the services authorized for that specific customer.

Once logged on, the customer is provided access to Interactive Merchant Marketing services that allow the customer to identify, locate, view, access, and manipulate merchant information, in which the customer wishes to solicit a customized and tailored merchant offer that is designed specifically for that customer.

The customer then instructs the Interactive Merchant Marketing system to send the customer's request to the targeted merchant for review and consideration.

The Interactive Merchant Marketing system records the customer request in the merchant's dedicated Interactive Merchant Marketing system resources, and notifies the specific merchant that there is a pending customer request. The notification is first placed on the merchant's dedicated Interactive Merchant Marketing Dashboard, and highlighted as an “Alert” to be viewed. The dedicated merchant Dashboard is a functional, graphical user interface that allows a merchant to view and administratively manage their Interactive Merchant Marketing business.

The merchant can option the Interactive Merchant Marketing system to additionally send merchant notifications to the merchant by utilizing alternative merchant communication resources, such as email, Social Networking platforms (ie; Facebook, Twitter, and the like), text messaging, as well as a myriad of other industry standard communication and messaging systems available today.

Once logged on to the Interactive Merchant Marketing system, the merchant can view the Alert and identify that the Alert is a customer request for a customized and tailored merchant offer, that is based on the detailed customer information contained in the text of the Alert.

The merchant can then access Interactive Merchant Marketing services that allow the merchant to create a customized and tailored offer to be sent to the requesting customer.

The merchant then instructs the Interactive Merchant Marketing system to send the merchant's new offer to the customer's Internet capable device that is recorded in the text contained in the Alert. The system can also obtain the customer's preferred contact method, by accessing the customer profile file, located in the systems dedicated, customer information folders.

The Interactive Merchant Marketing system formats the merchant's customized and tailored offer to match the presentation logic requirements of that specific customer's Internet capable device.

The Interactive Merchant Marketing system will then send the formatted merchant offer to the customer, via the Interactive Merchant Marketing, Customer Access Point (logically depicted in FIG. 1, as the “Customer Access Point”).

The customer receives and reviews the merchant's offer, along with a selectable “Customer Response” option [displayed on the customer's Internet capable device] that allows the customer to accept, decline, negotiate, or opt out of the merchant's solicitation.

Once the customer selects the appropriate response option, the program logic embedded in the merchant's formatted offer sends the customer response to The Interactive Merchant Marketing system, via the “Customer Access Point”, and instructs the system to send the customer response to the merchant.

The system sends the customer response to the merchant, via the “Merchant Access Point” that is associated with that specific merchant.

The merchant reviews the customer response and has the option of accessing additional Interactive Merchant Marketing system services to perform other administrative type merchant activities.

Throughout this entire process, the Interactive Merchant Marketing system stores the transaction data associated with every phase of the dialogue between the merchant and customer. This data can be viewed and queried for future use by the merchant.

The customer could have optionally chosen to create a list of targeted merchants, rather than a single merchant, and instructed the system to repeat the entire process with each of the targeted merchants.

Scenario 3:

A merchant can choose to federate with one or more other merchants [within the Interactive Merchant Marketing system] in an effort to provide a bundled merchant offering that is targeted for a single, or group of targeted customers.

The merchant accesses the Interactive Merchant Marketing “Federated” services, and establishes a symbiotic business relationship with other merchants in the system. The system creates a dedicated shared merchant workspace in which the merchants can communicate, collaborate, and manage the specific Federated merchant business instance.

The Federated merchant group utilizes the same Interactive Marketing Services as outlined in Scenario 1 and Scenario 2.

Scenario 4:

A customer can choose to federate with one or more other customers [within the Interactive Merchant Marketing system] in an effort to request a customized and tailored merchant offering, or a Federated merchant bundled offering, that is targeted for a group of interested customers.

The customer accesses the Interactive Merchant Marketing “Federated” services, and establishes a symbiotic business relationship with other customers in the system. The system creates a dedicated shared customer workspace in which the customers can communicate, collaborate, and manage this specific Federated customer business instance.

A group of customers can also be defined in the system as a single customer entity. Single entity customer groups can also Federate.

The Federated customer group utilizes the same Interactive Marketing Service as outlined in Scenario 1 and Scenario 2.

### FIELD OF THE INVENTION

The invention relates to the field of merchant to customer marketing. More specifically, the invention comprises an interactive merchant marketing service platform that facilitates a [merchant, or group of merchants], to directly and interactively, solicit a targeted [customer, or group of customers], to purchase or acquire the [merchant, or group of merchant's] products or services, by offering the targeted [customer, or group of customers], tailored or custom merchant discount(s), coupon(s), promotion(s), offer(s), based on the targeted customer's demographics, profiled interests and likes, as well as their buying propensity and patronage history, regarding the merchant's products or services.

Conversely, the interactive merchant marketing service platform also facilitates for a [customer, or group of customers], to directly and interactively solicit a targeted [merchant, or group of merchants], to approve or negotiate the [customer, or group of customer's] request for a tailored or custom discount(s), coupon(s), promotion(s), offer(s), on the [merchant, or group of merchant's] products or services.

### BRIEF SUMMARY OF THE INVENTION

The invention comprises a computing platform running Interactive Merchant Marketing software applications that support both online web based and mobile users.

The merchants are provided with dedicated Interactive Merchant Marketing compute resources and functionality that allows them to engage in an interactive marketing relationship with customers, that permits the merchant to develop, send and manage tailored and customized, discounts, coupons, promotions, and offerings provided to these targeted customers, as well as the capturing, data mining and dashboarding of the associated customer intelligence that was gathered in the process.

The invention also provides forecasting capabilities for the merchant that will allow the merchant to accurately forecast future purchases with precision and accuracy, through a profiling mechanism that will increase incremental revenue. Furthermore, the profile mechanism will enable the merchant to precisely forecast each individual customer's buying propensity to maximize the company's revenue to its full potential.

Conversely, customers are provided with dedicated compute resources and functionality that allows them to engage in an interactive marketing relationship with a merchant and request customized discounts, coupons, promotions, and offerings that are tailored specifically for that customer.

What is claimed is:

1. A system for facilitating a bi-directional communication between an input user connecting to an output user, that allows the input user to solicit a predetermined, targeted output user [via the system] accepting the input user solicitation. Throughout this entire process, the system stores the transaction data associated with each phase of the input user and output user dialogue for future use by the input user.

2. Furthermore, the output user has an option to modify the input user initial offer, and submit a modified input user offer for input user consideration and approval. The input user may accept or modify the input user initial offer, based on the output user response. Throughout this entire process, the system stores the transaction data associated with each phase of the input user and output user dialogue for future use by the input user.

3. A system for facilitating a bi-directional communication between an output user connecting to an input user, that allows the output user to solicit a predetermined, targeted input user [via the system] accepting the output user solicitation. Throughout this entire process, the system stores the transaction data associated with each phase of the input user and output user dialogue for future use by the input user.

4. Furthermore, the input user has the option to submit an offer to the output user based on the output user initial request. The output user may accept or modify the input user initial offer, based on the input user response. Throughout this entire process, the system stores the transaction data associated with each phase of the input user and output user dialogue for future use by the input user.
